(19) United States
(12) Patent Application Publication
(10) Pub. No.: US 2024/0412932 A1
(43) Pub. Date: Dec. 12, 2024

(54) ELECTROMAGNETIC CONTACTOR

(71) Applicant: FUJI ELECTRIC CO., LTD., Kawasaki-shi (JP)

(72) Inventors: Koujun KONISHI, Kounosu-city (JP); Takashi TSUTSUMI, Kounosu-city (JP); Yuya SAKURAI, Kounosu-city (JP); Yuma KUSANO, Kounosu-city (JP)

(73) Assignee: FUJI ELECTRIC CO., LTD., Kawasaki-shi (JP)

(21) Appl. No.: 18/643,055

(22) Filed: Apr. 23, 2024

(30) Foreign Application Priority Data
Jun. 9, 2023 (JP) 2023-095811

(51) Int. Cl. H01H 50/36; H01H 50/02

(52) U.S. Cl. CPC H01H 50/36; H01H 50/02

(57) ABSTRACT

To more effectively prevent separation of a contact unit at the time of short-circuit in an electromagnetic contactor. A capsule case is made of resin. A fixed yoke is arranged between a pair of fixed contact pieces, and at least a portion of the fixed yoke is held in a skeleton forming a capsule case. A movable yoke is disposed on a movable contact piece and is opposed to the fixed yoke. The fixed yoke and the movable yoke attract each other caused by a magnetic circuit being formed about an axis in a conduction direction in which current flows in the movable contact piece when a contact unit is closed.

### CROSS REFERENCE TO RELATED APPLICATIONS AND INCORPORATION BY REFERENCE

This application claims benefit of priority under 35 USC 119 based on Japanese Patent Application No. 2023-095811 filed on Jun. 9, 2023, the entire contents of which are incorporated by reference herein.

### TECHNICAL FIELD

The present invention relates to an electromagnetic contactor.

### BACKGROUND ART

PTL 1 (JP 2022-506868 A) discloses that in order to prevent separation (lifting) of a contact unit caused by an electromagnetic repulsive force when short-circuit current flows, a fixed yoke and a movable yoke are disposed. The fixed yoke and the movable yoke are configured to form a magnetic circuit about an axis in a conduction direction in which current flows in a movable contact piece and attract each other, and the fixed yoke is fixed to a holder that moves in an interlocked manner with a movable iron core and the movable yoke is fixed to the movable contact piece.

### SUMMARY OF INVENTION

### Technical Problem

In a configuration in which the fixed yoke is fixed to the holder that moves in an interlocked manner with the movable iron core, the fixed yoke is caused to be displaced in conjunction with the movable iron core. Therefore, when the fixed yoke and the movable yoke attract each other, a force in a closing direction generated by an electromagnet is caused to be reduced, as a result of which there is a possibility that separation of a contact unit caused by an electromagnetic repulsive force cannot be effectively prevented.

An object of the present invention is to more effectively prevent separation of a contact unit at the time of short-circuit in an electromagnetic contactor.

### Solution to Problem

An electromagnetic contactor according to one aspect of the present invention includes a container, a pair of fixed contact pieces, a movable contact piece, a fixed yoke, and a movable yoke. The container is made of resin. The pair of fixed contact pieces are fixed to the container in a penetrating manner, and on one end side of each of the fixed contact pieces, the one end side being located inside the container, a fixed contact is formed. On the movable contact piece, movable contacts facing the fixed contacts are formed on both end sides, and when the movable contact piece is displaced in the depth direction in the container, the movable contact piece causes a contact unit including the movable contacts and the fixed contacts to be opened or closed. The fixed yoke is arranged between the pair of fixed contact pieces, and at least a portion of the fixed yoke is held in a skeleton forming the container. The movable yoke is disposed on the movable contact piece and is opposed to the fixed yoke. The fixed yoke and the movable yoke attract each other caused by a magnetic circuit being formed about an axis in a conduction direction in which current flows in the movable contact piece when the contact unit is closed.

### Advantageous Effects of Invention

Since according to the present invention, the fixed yoke is held in the skeleton forming the container made of resin, even when the fixed yoke and the movable yoke attracts each other, a force in a closing direction generated by the electromagnet is never reduced. Therefore, it is possible to more effectively prevent separation of the contact unit at the time of short-circuit.

### BRIEF DESCRIPTION OF DRAWINGS

FIG. 1 is a diagram illustrative of an electromagnetic contactor;

FIG. 2 is a cross-sectional view of the electromagnetic contactor;

FIG. 3 is another cross-sectional view of the electromagnetic contactor;

FIGS. 4A and 4B are diagrams illustrative of a fixed yoke and a movable yoke;

FIGS. 5A and 5B are diagrams illustrative of a contact support;

FIG. 6 is a diagram illustrative of the fixed yoke held in a capsule case; and

FIGS. 7A and 7B are other diagrams illustrative of the fixed yoke held in the capsule case.

### DESCRIPTION OF EMBODIMENTS

An embodiment of the present invention will be described below, based on the drawings. Note that the respective drawings are schematic and do not necessarily depict the actual dimensions or precise configurations of practical implementation of the present invention. In addition, the following embodiment indicate a device and a method to embody the technical idea of the present invention by way of example, and do not limit the configuration to that described below. That is, the technical idea of the present invention can be subjected to a variety of alterations within the technical scope described in CLAIMS.

### Embodiment

### (Configuration)

In the following description, for descriptive purposes, three directions orthogonal to one another are assumed to be the vertical direction, the width direction, and the depth direction.

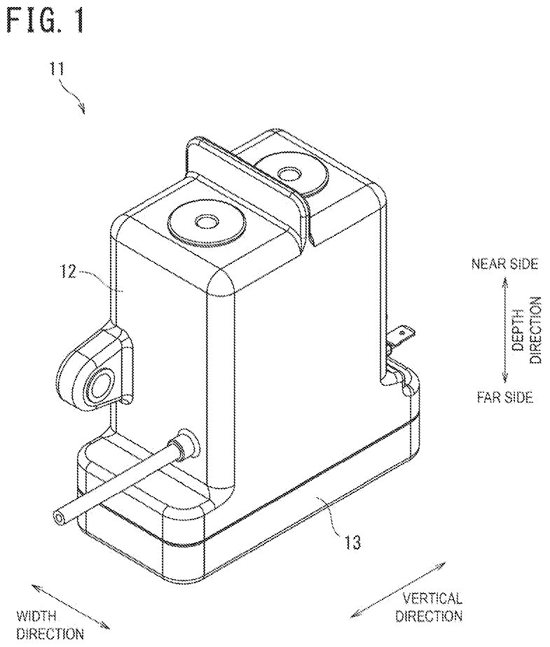

FIG. 1 is a diagram illustrative of an electromagnetic contactor 11.

In this drawing, the electromagnetic contactor 11 when viewed from one side in the vertical direction, one side in the width direction, and the near side in the depth direction is illustrated. The electromagnetic contactor 11 includes a capsule case 12 (container) and a capsule cover 13. The capsule case 12 is formed in a deep container shape that is made of resin having insulation properties and has both sides in the vertical direction, both sides in the width direction, and the near side in the depth direction closed and the far side in the depth direction opened. The capsule cover 13 is formed in a shallow container shape that is made of resin having insulation properties and has both sides in the vertical direction, both sides in the width direction, and the far side in the depth direction closed and the near side in the depth direction opened, is fitted into the far side in the depth direction of the capsule case 12, and is hermetically sealed.

The capsule case 12 and the capsule cover 13 are filled with pressurized insulating gas, such as hydrogen and nitrogen. For that purpose, not only are the capsule case 12 and the capsule cover 13 fixed to each other with epoxy resin-based adhesive, but also gas barrier coating is applied to the entire outer peripheral surface including a boundary portion, using laminated films of clay crystals. Specifically, exchanging interlayer ions in purified smectite and joining the laminated films with an organic binder, such as polyvinyl alcohol (PVA) and water-soluble nylon, causes the laminated films to exhibit labyrinth effect and thereby prevent permeation of gas molecules, such as hydrogen and nitrogen. The laminated films are stacked in the thickness direction, and the thickness thereof is, for example, 2 μm. The gas barrier coating is applied by a spray method in which coating liquid is formed into mist and applied to the capsule case 12 and the capsule cover 13, and is completed by being burned at a temperature at which interlayer ions are incorporated into clay crystals, for example, a temperature greater than or equal to 150° C. Since, as described above, gas barrier coating is applied to the entire outer peripheral surface, the outer peripheral shapes of the capsule case 12 and the capsule cover 13 are preferably formed in a polygon that is composed of planes that are flat and linear to the extent possible.

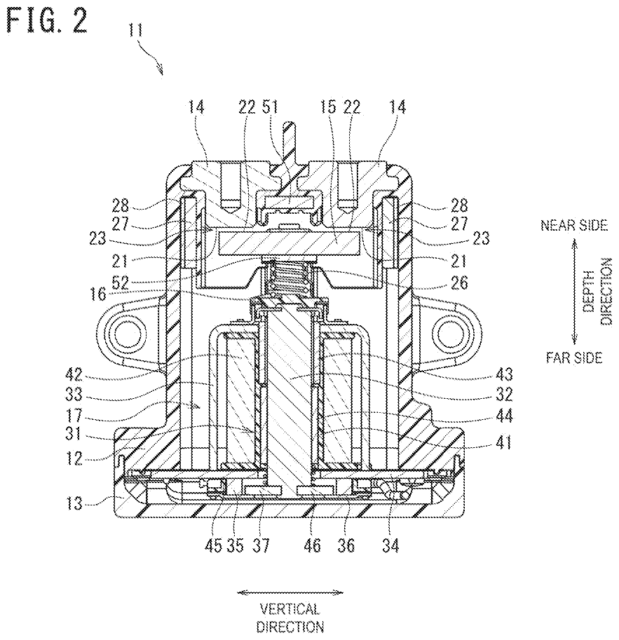

FIG. 2 is a cross-sectional view of the electromagnetic contactor 11.

In this drawing, a cross section of the electromagnetic contactor 11 passing the center in the width direction and taken along the vertical direction and the depth direction when viewed from one side in the width direction is illustrated.

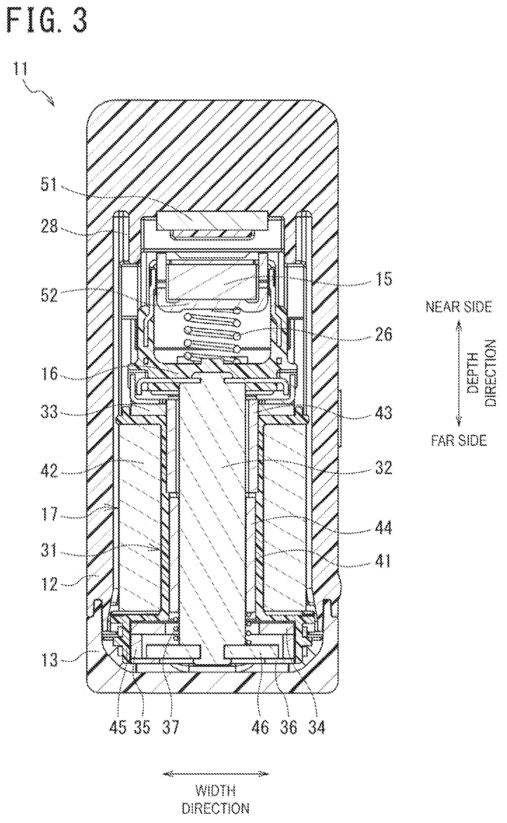

FIG. 3 is another cross-sectional view of the electromagnetic contactor 11.

In this drawing, a cross section of the electromagnetic contactor 11 passing the center in the vertical direction and taken along the width direction and the depth direction when viewed from one side in the vertical direction is illustrated.

First, a basic structure of the electromagnetic contactor 11 will be described. The electromagnetic contactor 11 includes a pair of fixed contact pieces 14, a movable contact piece 15, a contact support 16, and an electromagnet unit 17.

Each of the pair of fixed contact pieces 14 is made of a metal having conductivity and is formed in a substantially columnar shape extending in the depth direction. The pair of fixed contact pieces 14 are arranged in line in the vertical direction with a gap interposed therebetween, penetrate through the capsule case 12 from the inside to the outside of the capsule case 12, and are integrated with the capsule case 12 by insert molding. With regard to each of the fixed contact pieces 14, an end portion on the inner side in the vertical direction within an end surface facing the far side in the depth direction serves as a fixed contact 21.

The movable contact piece 15 is made of a metal having conductivity, is formed in a flat plate shape extending in the vertical direction and aligned along the vertical direction and the width direction, and is arranged on the far side in the depth direction of the pair of fixed contact pieces 14. With regard to the movable contact piece 15, end portions on both outer sides in the vertical direction within an end surface facing the near side in the depth direction serve as movable contacts 22 facing the fixed contacts 21. The fixed contacts 21 and the movable contacts 22 constitute a contact unit 23, and the contact unit 23 is opened or closed by displacement of the movable contact piece 15 along the depth direction.

The contact support 16 is formed in a frame shape having both sides in the width direction and the far side in the depth direction closed, and on the inside of the contact support 16, the movable contact piece 15 and a contact spring 26 are held. The contact spring 26 is a compression coil spring that expands and contracts in the depth direction and biases the movable contact piece 15 toward the near side in the depth direction. On the inside of the capsule case 12, permanent magnets 27 to induce an arc generated in the contact unit 23 and yokes 28 are held. Each of the permanent magnets 27 is formed in a flat plate shape, and the permanent magnets 27 are arranged on both sides in the vertical direction with the movable contact piece 15 interposed therebetween. Each of the yokes 28 is a U-shaped yoke closing the outer side in the vertical direction and both sides in the width direction and opening to the inner side in the vertical direction and is arranged on the outer side in the vertical direction of one of the permanent magnets 27.

The electromagnet unit 17 is arranged on the far side in the depth direction and includes a spool 31, a plunger 32, an outer yoke 33, a bottom yoke 34, a permanent magnet 35, an auxiliary yoke 36, and a back spring 37.

In the spool 31, a coil 42 is wound around a cylindrical winding shaft 41 that is made of resin having insulation properties and that extends in the depth direction. On the inside of the winding shaft 41, a cylindrical plunger ring 43 is fitted on the near side in the depth direction and a cylindrical sliding collar 44 is fitted on the far side in the depth direction. On the spool 31, a rib 45 that surrounds four sides orthogonal to the depth direction, in other words, both sides in the vertical direction and both sides in the width direction, is formed on the far side in the depth direction.

The plunger 32 is a columnar movable iron core extending in the depth direction and is inserted into the plunger ring 43 and the sliding collar 44 in an advanceable and retractable manner in the axial direction. The plunger 32 is longer than the winding shaft 41, and the contact support 16 and an armature 46 are joined to a near side end and a far side end in the depth direction of the plunger 32, respectively. The armature 46 is a disk-shaped yoke aligned along the vertical direction and the width direction.

The outer yoke 33 is a yoke that is formed in a substantially U-shape opening to the far side in the depth direction when viewed from the width direction and is disposed in such a manner as to cover both sides in the vertical direction and the near side in the depth direction of the spool 31. On the outer yoke 33, a near side end portion of the plunger ring 43 is fitted into a circular hole that penetrates through the outer yoke 33 in the depth direction.

The bottom yoke 34 is a plate-shaped yoke aligned along the vertical direction and the width direction, is arranged on the far side in the depth direction of the winding shaft 41 in the spool 31, and is fixed to far side ends on both sides of the outer yoke 33. In the bottom yoke 34, the plunger 32 passes through a circular hole that penetrates through the bottom yoke 34 in the depth direction.

The permanent magnet 35 is formed in a flat plate shape aligned along the vertical direction and the width direction, has a circular hole formed, the circular hole penetrating through the permanent magnet 35 in the depth direction, is fitted into the inner side of the rib 45, and is attracted and stuck on a far side surface of the bottom yoke 34.

The auxiliary yoke 36 is formed in a flat plate shape aligned along the vertical direction and the width direction, has a circular hole formed, the circular hole penetrating through the auxiliary yoke 36 in the depth direction, is fitted into the inner side of the rib 45, and is attracted and stuck on a far side surface of the permanent magnet 35. The armature 46 of the plunger 32 is arranged between the bottom yoke 34 and the auxiliary yoke 36.

The back spring 37 is a compression coil spring that expands and contracts in the depth direction, is interposed between the sliding collar 44 and the armature 46, and biases the plunger 32 toward the far side in the depth direction via the armature 46.

Because of the above-described configuration, in a non-excited state in which current is not applied to the coil 42, the plunger 32 is arranged in such a manner as to be displaced to the far side in the depth direction by magnetic force of the permanent magnet 35 and repulsive force of the back spring 37. Magnetic flux of the permanent magnet 35 starts from a near side surface of the permanent magnet 35, passes through the bottom yoke 34, the outer yoke 33, the plunger ring 43, the plunger 32, the armature 46, and the auxiliary yoke 36, and reaches the far side surface of the permanent magnet 35. By this magnetic circuit forming a closed loop, the armature 46 is attracted and stuck on a near side surface of the auxiliary yoke 36. When the plunger 32 is being displaced toward the far side in the depth direction in this manner, the contact is opened via the contact support 16 and is brought into a released state. On this occasion, the armature 46 is separated from the far side surface of the bottom yoke 34.

When, while the electromagnetic contactor 11 is in this state, current is applied to the coil 42 and the coil 42 is excited, the armature 46 is attracted and stuck on the far side surface of the bottom yoke 34 by a magnetic force of the coil 42. Because of this movement, the plunger 32 is arranged in such a manner as to be displaced to the near side in the depth direction against the magnetic force of the permanent magnet 35 and the repulsive force of the back spring 37. Magnetic flux of the coil 42 starts from an inner circumferential surface of the plunger ring 43, passes through the plunger 32, the armature 46, the bottom yoke 34, and the outer yoke 33, and reaches an outer circumferential surface of the plunger ring 43. By this magnetic circuit forming a closed loop, the armature 46 is attracted and stuck on the far side surface of the bottom yoke 34. While the plunger 32 is being displaced toward the near side in the depth direction in this manner, the contact is closed via the contact support 16 and is brought into a closed state. On this occasion, the armature 46 is separated from the near side surface of the auxiliary yoke 36.

Next, a structure for preventing separation (lifting) of the contact unit 23 caused by an electromagnetic repulsive force when short-circuit current flows will be described.

The electromagnetic contactor 11 includes a fixed yoke 51 and a movable yoke 52. The fixed yoke 51 is arranged between the pair of fixed contact pieces 14, and at least a portion of the fixed yoke 51 is held in a skeleton forming the capsule case 12. The movable yoke 52 is disposed on the movable contact piece 15 and is opposed to the fixed yoke 51 when the contact unit 23 is closed. The fixed yoke 51 and the movable yoke 52 attract each other caused by a magnetic circuit being formed about an axis in a conduction direction in which current flows in the movable contact piece 15 when the contact unit 23 is closed.

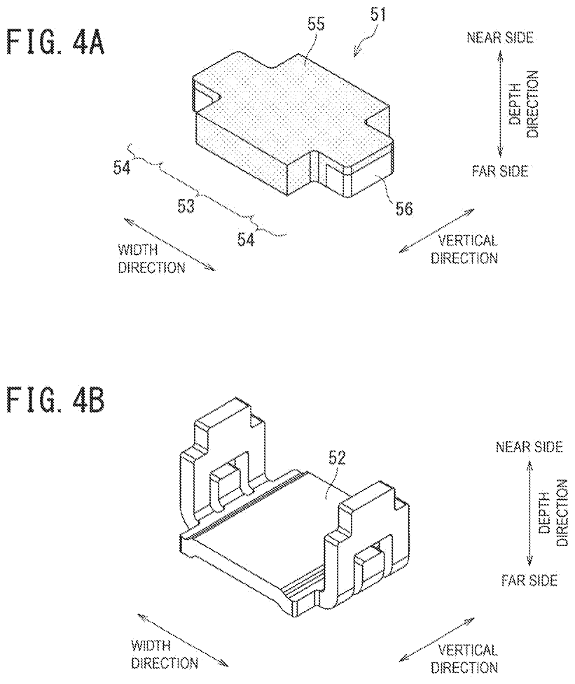

FIGS. 4A and 4B are diagrams illustrative of the fixed yoke 51 and the movable yoke 52.

FIG. 4A illustrates the fixed yoke 51 when viewed from one side in the vertical direction, one side in the width direction, and the near side in the depth direction. The fixed yoke 51 is a flat plate-shaped yoke extending in the width direction and aligned along the width direction and the vertical direction, includes a large dimension portion 53 and a small dimension portions 54, and is formed in a substantially cross shape when viewed from the depth direction. A dimension in the vertical direction of the large dimension portion 53 is comparatively large, and a dimension in the vertical direction of each small dimension portion 54 is comparatively small. A region illustrated by shading is an embedded portion 55 that is embedded in the skeleton of the capsule case 12, and the other regions are exposed portions 56. With regard to the large dimension portion 53, the whole is a portion of the embedded portion 55. With regard to each of the small dimension portions 54, a combination of a portion on the inner side in the width direction and a portion on the near side in the depth direction is a portion of the embedded portion 55, and a portion on the outer side in the width direction and the far side in the depth direction is one of the exposed portions 56. End surfaces on both sides in the vertical direction, an end surface on the outer side in the width direction, and an end surface on the far side in the depth direction are secured as the exposed portion 56.

FIG. 4B illustrates the movable yoke 52 when viewed from one side in the vertical direction, one side in the width direction, and the near side in the depth direction. The movable yoke 52 is a yoke that is formed in a substantially U-shape opening to the near side in the depth direction when viewed from the vertical direction and covers both sides in the width direction and the far side in the depth direction of the movable contact piece 15. With regard to the movable yoke 52, an inner dimension in the width direction corresponds to a dimension in the width direction of the movable contact piece 15, and an outer dimension in the width direction corresponds to a dimension in the width direction of the movable yoke 52. With regard to the movable yoke 52, tip surfaces of walls extending in the depth direction on both sides in the width direction are opposed to the pair of exposed portions 56 of the fixed yoke 51.

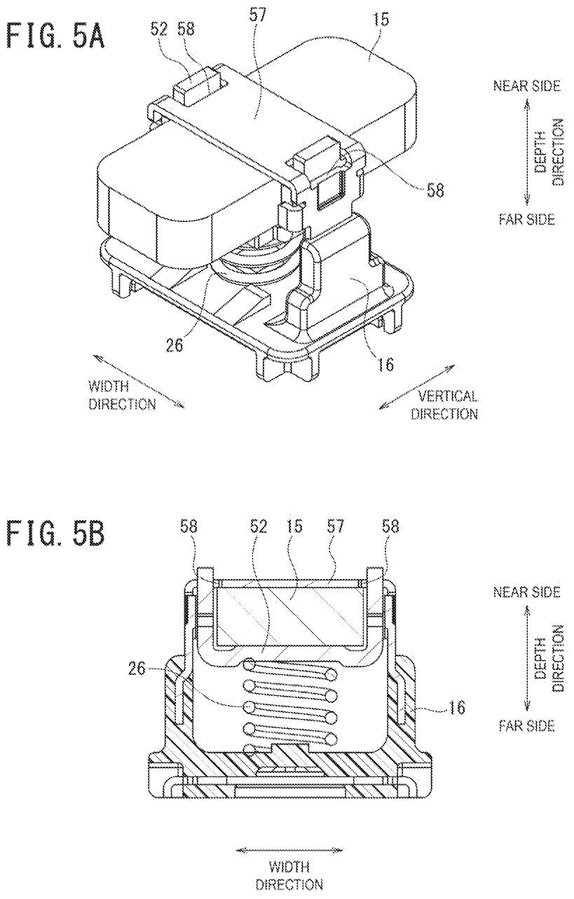

FIGS. 5A and 5B are diagrams illustrative of the contact support 16.

FIG. 5A illustrates the contact support 16 when viewed from one side in the vertical direction, one side in the width direction, and the near side in the depth direction. FIG. 5B illustrates a cross section of the contact support 16 passing the center in the vertical direction and taken along the width direction and the depth direction when viewed from one side in the vertical direction. The contact support 16 is formed in a substantially U-shape opening to the near side in the depth direction when viewed from the vertical direction, and on the both end sides in the width direction of the contact support 16, a cage 57 is integrated with the contact support 16 by insert molding. The cage 57 is formed in a substantially U-shape opening to the far side in the depth direction when viewed from the vertical direction and closes the near side in the depth direction of the contact support 16. Therefore, the contact support 16 is formed in a substantially square shape when viewed from the vertical direction in combination with the cage 57. In the cage 57, an opening portion 58 is formed in each of bent portions on both end sides in the width direction. On the inner side of the contact support 16 and the cage 57, the movable contact piece 15, the movable yoke 52, and the contact spring 26 are fitted in this order from the near side in the depth direction, and from each of the opening portions 58 of the cage 57, one of both ends of the movable yoke 52 project to the near side in the depth direction.

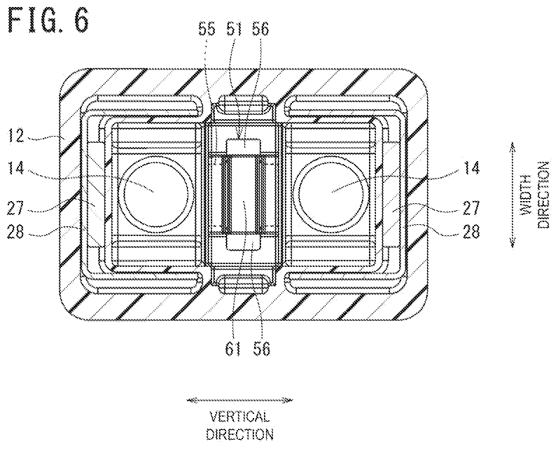

FIG. 6 is a diagram illustrative of the fixed yoke 51 held in the capsule case 12.

In this drawing, a cross section of the capsule case 12 passing a position on the far side in the depth direction of the fixed contact pieces 14 and taken along the vertical direction and the width direction when viewed from the far side in the depth direction is illustrated. The fixed yoke 51 is embedded in a skeleton 61 forming a ceiling of the capsule case 12, and the exposed portions 56 located on both end sides in the width direction of the fixed yoke 51 are exposed. The pair of exposed portions 56 and both ends in the width direction of the movable yoke 52 are opposed to each other in the depth direction. In order to secure a contact wipe amount, the fixed yoke 51 and the movable yoke 52 are set in such a manner that when the contact unit 23 is in a closed state, the fixed yoke 51 and the movable yoke 52 are in a non-contact state.

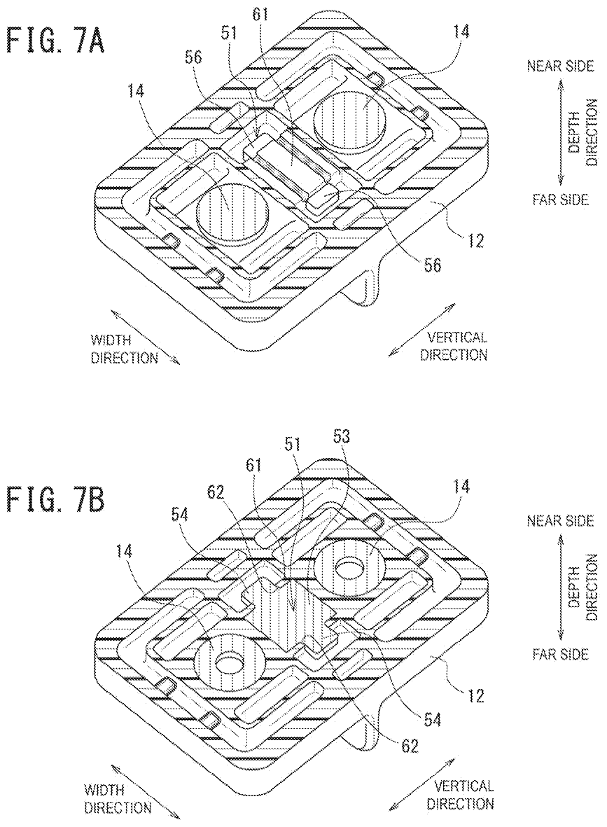

FIGS. 7A and 7B are diagrams illustrative of the fixed yoke 51 held in the capsule case 12.

FIG. 7A illustrates a cross section of the capsule case 12 passing a position on the far side in the depth direction of the skeleton 61 and taken along the vertical direction and the width direction when viewed from one side in the vertical direction, the other side in the width direction, and the far side in the depth direction. FIG. 7B illustrates a cross section of the capsule case 12 passing the fixed yoke 51 and taken along the vertical direction and the width direction when viewed from one side in the vertical direction, the other side in the width direction, and the far side in the depth direction. On each of both end surfaces in the width direction of the skeleton 61, an opening portion 62 is formed, and each of the small dimension portions 54 of the fixed yoke 51 projects and the exposed portion 56 of the small dimension portion 54 is exposed from one of the opening portions 62. That is, in the skeleton 61, a cavity penetrating in the width direction is formed, and the fixed yoke 51 is held in the cavity. Since the fixed yoke 51 is integrated with the skeleton 61 of the capsule case 12 by insert molding, the embedded portion 55 is in close contact with the opening portions 62.

### Advantageous Effects

Next, main advantageous effects of the embodiment will be described.

The electromagnetic contactor 11 includes the capsule case 12, the pair of fixed contact pieces 14, the movable contact piece 15, the fixed yoke 51, and the movable yoke 52. The capsule case 12 is made of resin. The pair of fixed contact pieces 14 are fixed to the capsule case 12 in a penetrating manner, and on one end side of each of the fixed contact pieces 14, the one end side being located inside the capsule case 12, one of the fixed contacts 21 is formed. On the movable contact piece 15, the movable contacts 22 facing the fixed contacts 21 are formed on both end sides, and when the movable contact piece 15 is displaced in the depth direction in the capsule case 12, the movable contact piece 15 causes the contact unit 23 including the movable contacts 22 and the fixed contacts 21 to be opened or closed. The fixed yoke 51 is arranged between the pair of fixed contact pieces 14, and at least a portion of the fixed yoke 51 is held in the skeleton 61 forming the capsule case 12. The movable yoke 52 is disposed on the movable contact piece 15 and is opposed to the fixed yoke 51. The fixed yoke 51 and the movable yoke 52 attract each other caused by a magnetic circuit being formed about an axis in a conduction direction in which current flows in the movable contact piece 15 when the contact unit 23 is closed. Since according to this configuration, the fixed yoke 51 is held in the skeleton 61 forming the capsule case 12 made of resin, even when the fixed yoke 51 and the movable yoke 52 attracts each other, a force in a closing direction generated by the electromagnet unit 17 is never reduced. Therefore, it is possible to more effectively prevent separation of the contact unit 23 at the time of short-circuit. By the capsule case 12 being made of resin, a degree of freedom in designing a structure to hold the fixed yoke 51 in the skeleton 61 is improved.

On the skeleton 61, the opening portions 62 to cause portions of the fixed yoke 51 to be exposed are formed. Because of this configuration, the fixed yoke 51 can be mounted on a mold at the time of insert molding, using the portions to be exposed after molding.

The fixed yoke 51 is formed in a flat plate shape extending in a direction orthogonal to the movable contact piece 15 when viewed from the depth direction and includes the embedded portion 55 and the exposed portions 56. The embedded portion 55 is embedded in the skeleton 61. The exposed portions 56 are exposed from the opening portions 62. Because of this configuration, the fixed yoke 51 can be mounted on a mold at the time of insert molding, using the portions that are to project from the opening portions 62 after molding. In particular, the end surfaces on both sides in the vertical direction, the end surface on the outer side in the width direction, and the end surface on the far side in the depth direction of each of the small dimension portions 54 being secured as one of the exposed portions 56 enables positioning of the fixed yoke 51 with respect to the mold to be performed.

The embedded portion 55 is larger than the opening portions 62 when viewed from the projecting direction of the exposed portions 56. Because of this configuration, it is possible to prevent misalignment or falling-off of the fixed yoke 51 with respect to the skeleton 61.

The fixed yoke 51 has the embedded portion 55 closely adhering to an inner surface of the skeleton 61. Because of this configuration, it is possible to prevent unsteadiness of the fixed yoke 51.

The movable yoke 52 is formed in a U-shape opening to the fixed yoke 51 when the movable contact piece 15 is viewed from the conduction direction. Because of this configuration, a magnetic circuit can be formed about an axis in the conduction direction in which current flows in the movable contact piece 15 when the contact unit 23 is closed. In addition, in a configuration in which the fixed yoke 51 is formed in a U-shape, the movable contact piece 15 is caused to enter the inside of the fixed yoke when the contact unit 23 is closed and high-precision motion is thus required to be performed, as a result of which a design cost increases. In contrast, in the configuration in which the movable yoke 52 is formed in a U-shape, since the movable contact piece 15 is integrated with the movable yoke 52 with the movable contact piece 15 fitted in the movable yoke 52, high-precision motion is never required when the contact unit 23 is closed, which enables a design cost to be suppressed.

To the capsule case 12, gas barrier coating is applied using laminated films of clay crystals. This configuration can suppress permeation of gas molecules, such as hydrogen and nitrogen, and thereby prevent leakage of pressurized insulating gas.

The fixed yoke 51 is internally integrated with the skeleton 61 by insert molding. Because of this configuration, it is possible to, by causing the embedded portion 55 of the fixed yoke 51 to closely adhere to the inner surface of the skeleton 61, prevent unsteadiness of the fixed yoke 51. In addition, assembly of the fixed yoke 51 in the skeleton 61 becomes unnecessary, and joint strength is also improved.

Next, a comparative example will be described.

Herein, a structure in which a fixed yoke is fixed to a holder that moves in an interlocked manner with a movable iron core and a movable yoke is fixed to a movable contact piece will be described as a comparative example. In a configuration in which the fixed yoke is fixed to the holder that moves in an interlocked manner with the movable iron core as described above, the fixed yoke is caused to be displaced in conjunction with the movable iron core. Therefore, when the fixed yoke and the movable yoke attract each other, a force in a closing direction generated by an electromagnet unit is caused to be reduced, as a result of which there is a possibility that separation of a contact unit caused by an electromagnetic repulsive force cannot be effectively prevented.

### Variations

Although in the embodiment, a configuration in which each of the fixed contact pieces 14 is formed in a columnar shape was described, the present invention is not limited to the configuration. That is, the shape of each of the fixed contact pieces 14 can be arbitrarily defined, and each of the fixed contact pieces 14 may be formed in, for example, a flat plate shape extending in the vertical direction and aligned along the vertical direction and the width direction.

Although in the embodiment, a partition wall is formed on the inside of the capsule case 12 and the contact unit 23 and the permanent magnet 27 are separated from each other, the present invention is not limited to the configuration. That is, a configuration in which by adding an insulating holder serving as an arc barrier on the inside of the capsule case 12, the contact unit 23 and the permanent magnet 27 are separated from each other may be employed.

While the present invention has been described with reference to the definite number of embodiments, the scope of the present invention is not limited thereto and improvements and modifications of the embodiments based on the above disclosure are obvious to a person skilled in the art.

### REFERENCE SIGNS LIST

11 Electromagnetic contactor
12 Capsule case
13 Capsule cover
14 Fixed contact piece
15 Movable contact piece
17 Electromagnet unit
21 Fixed contact
22 Movable contact
23 Contact unit
26 Contact spring
27 Permanent magnet
28 Yoke
31 Spool
32 Plunger
33 Outer yoke
34 Bottom yoke
35 Permanent magnet
36 Auxiliary yoke
37 Back spring
41 Winding shaft
42 Coil
43 Plunger ring
44 Sliding collar
45 Rib
46 Armature
51 Fixed yoke
52 Movable yoke
53 Large dimension portion
54 Small dimension portion
55 Embedded portion
56 Exposed portion
57 Cage
58 Opening portion
61 Skeleton
62 Opening portion

1. An electromagnetic contactor comprising:
a container made of resin;
a pair of fixed contact pieces fixed to the container in a penetrating manner and on one end side of each of which, the one end side being located inside the container, a fixed contact is formed;
a movable contact piece on both end sides of which movable contacts facing the fixed contacts are formed, the movable contact piece being configured to, when the movable contact piece is displaced in a depth direction in the container, cause a contact unit including the movable contacts and the fixed contacts to be opened or closed;
a fixed yoke arranged between the pair of fixed contact pieces and at least a portion of which is held in a skeleton forming the container; and
a movable yoke disposed on the movable contact piece and opposed to the fixed yoke,
wherein the fixed yoke and the movable yoke attract each other caused by a magnetic circuit being formed about an axis in a conduction direction in which current flows in the movable contact piece when the contact unit is closed.

2. The electromagnetic contactor according to claim 1, wherein on the skeleton, an opening portion to cause a portion of the fixed yoke to be exposed is formed.

3. The electromagnetic contactor according to claim 2, wherein
the fixed yoke is formed in a flat plate shape extending in a direction orthogonal to the movable contact piece when viewed from a depth direction and
includes:
an embedded portion embedded in the skeleton; and
an exposed portion projecting from the opening portion.

4. The electromagnetic contactor according to claim 3, wherein the embedded portion is larger than the opening portion when viewed from a projecting direction of the exposed portion.

5. The electromagnetic contactor according to claim 3, wherein the fixed yoke has the embedded portion closely adhering to an inner surface of the skeleton.

6. The electromagnetic contactor according to claim 3, wherein the movable yoke is formed in a U-shape opening to the fixed yoke when the movable contact piece is viewed from a conduction direction.

7. The electromagnetic contactor according to claim 1, wherein to the container, gas barrier coating is applied using laminated films of clay crystals.

8. The electromagnetic contactor according to claim 1, wherein the fixed yoke is internally integrated with the skeleton by insert molding.
